(19) United States
(12) Patent Application Publication
(10) Pub. No.: US 2006/0268901 A1
(43) Pub. Date: Nov. 30, 2006

(54) Method and apparatus for providing low-latency secure session continuity between mobile nodes

(76) Inventors: Vinod Kumar Choyi, Ottawa (CA); Michel Barbeau, Ottawa (CA)

Correspondence Address: ROSS D. SNYDER & ASSOCIATES, INC., PO BOX 164075, AUSTIN, TX, 78716-4075, US

(21) Appl. No.: 11/327,304

(22) Filed: Jan. 6, 2006

Related U.S. Application Data
(60) Provisional application No. 60/642,255, filed on Jan. 7, 2005.
(60) Provisional application No. 60/642,690, filed on Jan. 10, 2005.

(51) Int. Cl. H04L 12/56

(52) U.S. Cl. 370/401; 370/310

(57) ABSTRACT

In accordance with at least one embodiment of the present invention, IP application traffic can be provided confidentiality to and from one or more mobile nodes (MNs) belonging to the same domain even when such MNs are remotely located. It is possible to provide, preferably at all times, a similar level of confidentiality and integrity in communications between MNs as is typically provided within a corporate environment (e.g., within a secured intranet). Secure and efficient communication is provided when one or more MNs is communicating via a connection that cannot be presumed to be inherently secure, for example, a connection to a public network such as the internet or a network outside of a secured intranet.

### CROSS-REFERENCE TO RELATED APPLICATIONS

This application claims the benefit of U.S. Provisional Application No. 60/642,255, filed Jan. 7, 2005, and U.S. Provisional Application No. 60/642,690, filed Jan. 10, 2005.

The present application is related to a co-pending application for a “METHOD AND APPARATUS FOR PROVIDING ROUTE-OPTIMIZED SECURE SESSION CONTINUITY BETWEEN MOBILE NODES” (Attorney Docket No. 1400.1500550) being filed on the same day as the present application.

### BACKGROUND OF THE INVENTION

(1) Field of the Invention

The present invention relates generally to mobile networking and, more particularly, to low-latency secure networking involving one or more mobile nodes.

(2) Description of the Related Art

Characteristics of wireless communications contribute to increasing the difficulty of providing secure communications in a wireless environment as compared to fixed (i.e., non-wireless) networks. On the other hand, wireless networks such as global system for mobile communication (GSM), personal communication system (PCS), and code division multiple access (CDMA), which have been predominantly circuit-switched voice networks, have typically not provided full internet access and, therefore, have been somewhat sheltered from vulnerabilities such as those typical of the internet. With the introduction of the internet protocol (IP) multimedia subsystems (IMS) solution and related technology, data, voice, and video will be accessible over wireless connections, such as those using universal mobile telecommunication system (UMTS) and code division multiple access 2000 (CDMA2000, e.g., international mobile telecommunications (IMT)-CDMA multi-carrier, phase I radio transmission technology (IXRTT), or phase 3 radio transmission technology (3xRTT)) via the internet. Mobile equipment has the capability to work with multiple radio interfaces using heterogeneous radio access networks. Mobile subscribers have also become “truly mobile” since they are not constrained by mobile equipment, networks, and applications. However, there typically remains a desire for protection of information communicated between individuals, which may be manifested as a distinction between private and public communications. Privacy is beneficial not only from a network perspective, but also according to a peer-to-peer communication model.

A problem exists in the difficulty of providing IP application traffic confidentiality to mobile users belonging to the same domain. One challenge heretofore faced has been to ensure, preferably at all times, a similar level of confidentiality and integrity in communications between mobile nodes (MNs) (or a MN and one or more fixed nodes) as provided within a fixed intranet (e.g., a fixed corporate environment or a fixed home environment).

The goal of confidentiality and mobility has not been adequately achieved. On the one hand, the internet key exchange (IKE) protocol can be used for negotiating the security associations (SAs) for tunnels of virtual private networks (VPNs). On the other hand, the mobile IP (MIP) protocol can be used to support mobility of IP nodes. When used together, the following issue arises: a SA of a VPN tunnel (VPN T) is related to two IP addresses, one for each end-point of the tunnel. A MN has a dual identity, a permanent home address (HoA) and a temporary care-of address (CoA), which is typically related to its geographical location. The HoA is used to identify an end-point of a VPN tunnel. From the HoA, traffic can be redirected to the current location of a MN. If the CoA is used as the end-point of a VPN tunnel, then a mechanism is to be provided to update the SA whenever the CoA is changed.

An architecture termed secure universal mobility (SUM) attempts to address both confidentiality and mobility. Three distinct areas are defined. One such area is the intranet, which is a trusted area guarded by a firewall. A second area is the de-militarized zone (DMZ), which is accessible outside the intranet through another firewall with relatively weaker control. A third area is the public internet, which may be presumed not to be inherently secure. SUM is MIP-based. Each MN has two HoAs, an internal HoA (i-HoA) and an external HoA (x-HoA). The i-HoA serves as identity in the private address space of the intranet. The x-HoA serves as identity in the public address space of the internet. There are two kinds of home agents (HAs), namely, an internal HA (i-HA) and an external HA (x-HA). The i-HA deals with intranet mobility and keeps track of internal CoA (i-CoA) to internal HoA (i-HoA) bindings. The x-HA deals with external mobility and keeps track of external CoA (x-CoA) to external HoA (x-HoA) bindings. The x-HA is located in the DMZ. There is a VPN gateway (VPN GW) that bridges the intranet and DMZ. While a MN is in the internet, confidentiality and integrity of data traffic are provided using an IP Security (IPSec) tunnel, the endpoints of which are the VPN GW's public address and MN's x-HoA.

A total of three tunnels are established to provide intranet private access to a MN visiting a foreign network. Following the acquisition of an x-CoA, a MN registers the x-CoA to the x-HA, thus binding the x-HoA with the x-CoA. This results in the establishment of an MIP tunnel which endpoints are the x-HA's address and MN's x-CoA. Then the MN initiates the establishment of an IPSec tunnel with the VPN GW, using its x-HoA. This results in the creation of an entry on the private intranet to the MN. The MN then registers a binding consisting of the intranet address of the VPN GW paired with the MN's i-HoA. This results in the creation of a third tunnel, of MIP type, between the i-HA and VPN GW.

Intranet traffic destined to the MN is intercepted by the i-HA then tunneled to the VPN GW. The latter securely redirects the traffic, using a VPN tunnel, to the x-HoA of the MN. The traffic is intercepted by the x-HA, which in turn tunnels it to the current location of the MN.

If the SA is bound to the x-CoA, then re-negotiation of the SAs has to be performed each time a new x-CoA is acquired by the MN. Setup time involves a minimum of four round-trip times (RTTs), as follows: one RTT for the internal registration, a minimum of two RTTs for the IPSec tunnel establishment (the use of IKE protocol is assumed), and one RTT for the external registration. The intranet traffic destined to the MN goes through two HAs. This approach suffers from double triangle routing, which refers to the four RTTs of network latency arising from traversing a triangular network topology multiple times.

While visiting a foreign network, the traffic from a correspondent node (CN) to a MN is first delivered to the internal home network. In the home network, the i-HA is aware of the fact that the MN is away. It intercepts the traffic destined to MN and tunnels it to the current location of MN. Hence, traffic destined to the MN is subject to double network latency.

The above techniques do not adequately address the condition when two MNs communicate with one another when they are both outside the intranet (e.g., protected subnetwork). Moreover, they pose certain deficiencies for the condition when only one MN is outside. Also, they fail to provide a path that is optimized to support low-latency connections. Latency (and latency variation) can impair performance. Thus, a method and apparatus is needed to allow secure and efficient communication when one or more MNs are communicating via connections that cannot reasonably be presumed to be inherently secure.

### BRIEF DESCRIPTION OF THE SEVERAL VIEWS OF THE DRAWINGS

The present invention may be better understood, and its features made apparent to those skilled in the art by referencing the accompanying drawings.

FIG. 1 is a block diagram illustrating apparatus in accordance with at least one embodiment of the present invention.

FIG. 2 is a block diagram illustrating a mobile-aware gateway (MAG) 105 in accordance with at least one embodiment of the present invention.

FIG. 3 is a diagram illustrating connections among elements including a MN 103/104 and a CN 110 in accordance with at least one embodiment of the present invention.

FIG. 4 is a diagram illustrating connections among elements including MN1 103 and MN2 104 in accordance with at least one embodiment of the present invention.

FIG. 5 is a flow diagram illustrating a method involving communication between a MN and a CN in accordance with at least one embodiment of the present invention.

FIG. 6 is a flow diagram illustrating a method for practicing step 501 of FIG. 5 in accordance with at least one embodiment of the present invention.

FIG. 7 is a flow diagram illustrating a method for practicing step 503 of FIG. 5 in accordance with at least one embodiment of the present invention.

FIG. 8 is a flow diagram illustrating a method for practicing step 506 of FIG. 5 in accordance with at least one embodiment of the present invention.

FIG. 9 is a flow diagram illustrating a method for practicing step 502 of FIG. 5 in accordance with at least one embodiment of the present invention.

FIG. 10 is a flow diagram illustrating a method for practicing step 505 of FIG. 5 in accordance with at least one embodiment of the present invention.

FIG. 11 is a flow diagram illustrating a method involving communication between a first MN and a second MN in accordance with at least one embodiment of the present invention.

FIG. 12 is a block diagram illustrating information communicated in accordance with at least one embodiment of the present invention.

The use of the same reference symbols in different drawings indicates similar or identical items.

### DETAILED DESCRIPTION OF THE INVENTION

In accordance with at least one embodiment of the present invention, IP application traffic can be provided confidentially to and from one or more MNs belonging to the same domain even when such MNs are outside a corporate or protected domain, such a an intranet providing controlled access to and/or from a public network, such as the internet. It is possible to provide, preferably at all times, a similar level of confidentiality and integrity in communications between MNs as is typically provided within a corporate environment (e.g., within a secured intranet), and such confidentiality and integrity may be provided for any type of network, be it in a corporate, home, academic, governmental, non-profit, or other context. Secure and efficient communication is provided when one or more MNs is communicating via a connection that cannot be presumed to be inherently secure, for example, a connection to a public network such as the internet or a network outside of a secured intranet.

At least one embodiment of the present invention may be implemented so as to offer secure connections between peer-to-peer mobiles by using VPN technologies, such as those based on IP Security (IPSec). Mobility management is provided that may be implemented so as to be compatible with the Mobile IP (MIP) along with a route-optimization (RO) technique. In accordance with at least one embodiment of the present invention, latency suffered by real-time traffic can be reduced when traversing tunnels, such as IPSec and MIP tunnels.

Mechanisms are described for providing secure and seamless session continuity between MNs when traversing between intranet and public networks. Routing of VPN tunnels is optimized and re-negotiation of IPSec Security Associations (SAs) after handoffs is avoided. Thus, triangle routing is avoided.

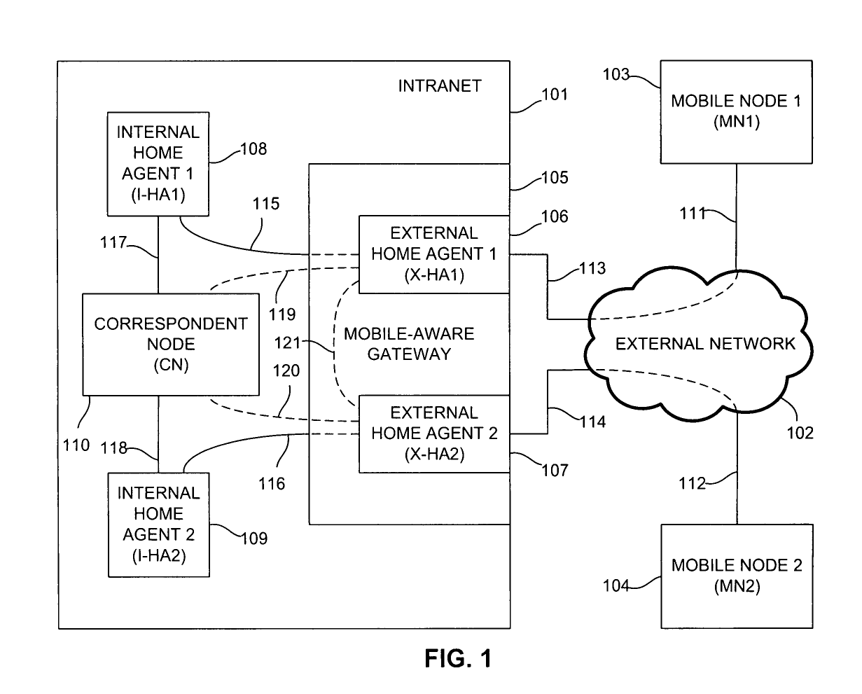

FIG. 1 is a block diagram illustrating apparatus in accordance with at least one embodiment of the present invention. The apparatus comprises an intranet 101, a first mobile node (MN1) 103 and/or a second mobile node (MN2) 104, and an external network 102 coupling MN1 103 and/or MN2 104 to the intranet 101. The intranet 101 preferably comprises a mobile-aware gateway (MAG) 105, a first internal home agent (i-HA1) 108 and/or a second home agent (i-HA2) 109, and a correspondent node (CN) 110. The MAG 105 preferably comprises a first external home agent (x-HA1) 106 and/or a second external home agent (x-HA2) 107.

The MN1 103 is coupled to external network 102 via network connection 111. The MN2 104 is coupled to external network 102 via network connection 112. The MAG 105 is coupled to external network 102, for example, via network connection 113, which may be coupled to the MN 1103 via external network 102 and network connection 111, and/or via network connection 114, which may be coupled to MN2 104 via external network 102 and network connection 112. An example of the external network 102 in accordance with at least one embodiment of the present invention is the internet, which may include other networks capable of providing access to the internet, such as other intranets besides intranet 101, as well as other wired and/or wireless networks, such as cellular wireless networks.

The x-HA 1106 is coupled to the i-HA 1108 via intranet connection 115. The x-HA2 107 is coupled to the i-HA2 109 via intranet connection 116. The i-HA1 108 is coupled to the CN 110 via intranet connection 117. The i-HA2 109 is coupled to the CN 110 via intranet connection 118. Preferably, the x-HA1 106 can be coupled to the CN 110 via intranet connection 119, and the x-HA2 107 can be coupled to the CN 110 via intranet connection 120. Preferably, the x-HA 1106 can be coupled to the x-HA 1 107 via connection 121, which is preferably implemented within the MAG 105.

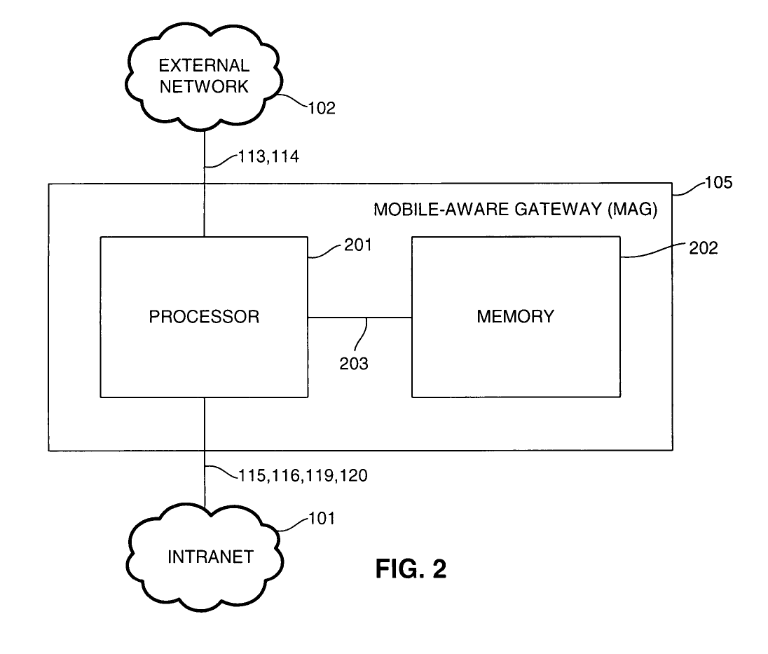

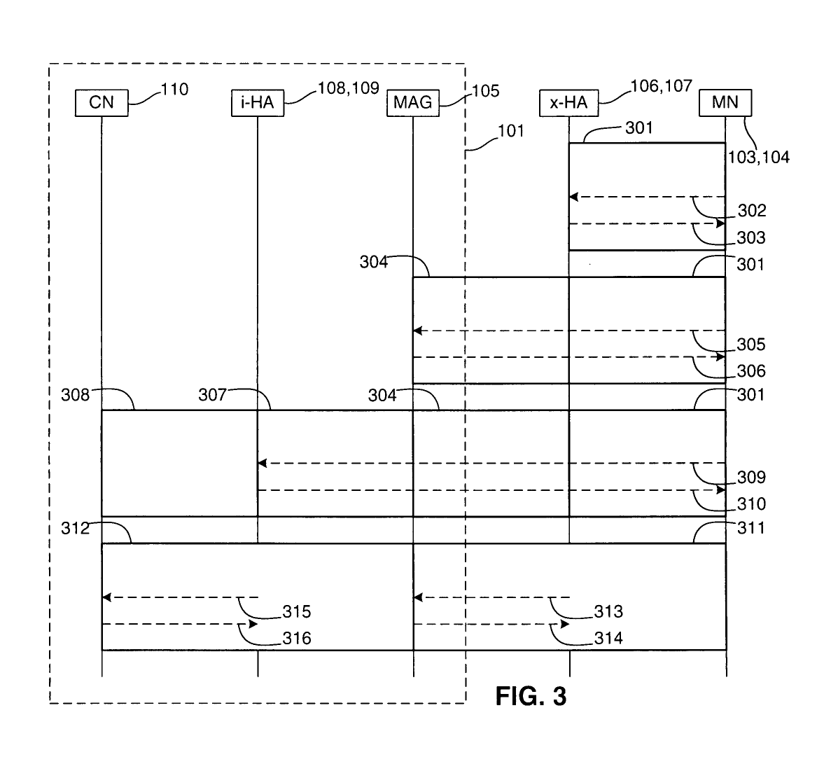

FIG. 2 is a block diagram illustrating a MAG 105 in accordance with at least one embodiment of the present invention. The MAG 105 preferably comprises a processor 201 and a memory 202. The processor 201 is coupled to the memory 202 via connection 203. The processor 201 is preferably coupled to external network 102 via a connection such as one or more of network connections 113 and 114. The processor 201 is preferably coupled to the intranet 101 or elements thereof via a connection such as one or more of intranet connections 115, 116, 119, and 120. The processing module may be a single processing device or a plurality of processing devices. Such a processing device may be a microprocessor, microcomputer, microcontroller, digital signal processor, central processing unit, state machine, logic circuitry, and/or any device that manipulates signals (analog or digital) based on operational instructions. The memory may be a single memory device or a plurality of memory devices. Such a memory device may be a read only memory, random access memory, magnetic tape memory, floppy disk memory, hard disk memory, DVD memory, CD memory, and/or any device that stores the operational and/or programming instructions. Note that if the processing module implements one or more functions via a state machine or logic circuitry, the memory containing the corresponding operational instructions would be embedded in the circuitry comprising the state machine and/or logic circuitry. The operational instructions stored in the memory and executed by the processing module will be discussed in greater detail with reference to FIGS. 3-11 below.

Given two MNs, e.g., MN1 and MN2, intended to have access to an intranet, several scenarios may exist. One possibility is that both MN1 and MN2 are in the intranet (e.g., corporate network). Another possibility is that MN is within the intranet and MN2 is outside the intranet. Yet another possibility is that both MN1 and MN2 are outside the intranet.

If both MNs are directly connected within the intranet, communication between MNs within the private domain is protected by firewalls, network address translation (NAT) techniques, and intrusion detection and prevention mechanisms. Mobility within the intranet can be supported using MIP.

When one MN is outside the intranet, secure communications can be provided using an IPSec tunnel from the MN in a visited (i.e., external) network to the intranet via a VPN gateway (VPN-GW), while MIP can be used to support mobility. A challenge is to ensure that re-negotiation of IPSec SAs is not done each time a network-layer handoff is performed by the MN. In accordance with at least one embodiment of the present invention, not only can that challenge be met, but also other benefits are obtained, such as reduced latency through route optimization (RO).

While a scenario in which multiple MNs are outside an intranet can be handled as multiple instances of one MN being outside the intranet, such an approach does not necessarily provide route-optimized and low-latency communication between the multiple MNs. In accordance with at least one embodiment of the present invention, such features may be provided.

At least one embodiment of the present invention provides secure and efficient communications when one MN is outside the intranet or when multiple MNs are outside the intranet. It should be noted that implementation of an embodiment of the present invention is not conditioned upon the existence of an intranet; a MAG may be used in absence of other intranet elements to provide secure and efficient communications between multiple nodes located anywhere. That understanding should be remembered whenever reference is made herein to MNs with respect to an intranet. At least one embodiment of the present invention may be implemented in accordance with features of the Secure Universal Mobility (SUM) architecture described by Dutta et al. (A. Dutta, T. Zhang, S. Madhani, K. Taniuchi, K. Fujimoto, Y. Katsube, Y. Ohba, and H. Schulzrinne, “Secure Universal Mobility for Wireless Internet,” First ACM International Workshop on wireless Mobile Applications and Services on WLAN Spots (WMASH), Philadelphia, pp. 71-80 October 2004.) When one MN is outside the intranet, SUM suffers from a double triangle routing problem. At least one embodiment of the present invention overcomes this problem by integrating an adapted MIP route optimization technique to the SUM architecture.

When multiple MNs are outside the intranet, it may be beneficial for mobility and VPN management to be coordinated in order to achieve a degree of optimization. Therefore, the VPN-GW and external Home Agent (x-HA) roles are preferably integrated into a single entity referred to as a mobile-aware VPN gateway (MAG. Such integration enables the MAG to perform mobility management in conjunction with VPN functions. One manner in which MAG functionality may be implemented is to completely involve the MAG in the communications between the two MNs. In short, the MAG is involved in the setup and operation of VPN tunnels and the MIP tunnels. Another manner in which MAG functionality may be implemented, which is an optimization of the first, is for the MAG to be involved in key distribution and tunnel-setup but then to allow communication without the need for continued MAG activity. In contrast to the first manner of complete MAG involvement, the user traffic flows through route-optimized paths.

In accordance with at least one embodiment of the present invention, the VPN-GW and x-HA may be combined into a single device that is a mobility-aware VPN Gateway (MAG). It should be noted that, in the FIG. 3, a separate x-HA and MAG are shown, but the combined MAG is shown in FIG. 4 for both the MN-to-MN case and the case where an end-to-end secure tunnel is established between MNs. The separate x-HA and MAG are shown to illustrate that the invention can be implemented in the context of the SUM architecture described by Dutta et al. It should be understood that the x-HA and the MAG may be implemented separately but that benefits may be obtained by implementing the x-HA functionality within the MAG.

When a mobile node (MN) moves out of the protected intranet, several steps may be performed to maintain or establish communication with the MN. According to a first step, MIP registration occurs with the external home agent (x-HA). The MN registers its x-CoA with the MAG, which preferably has the x-HA functionality implemented within it. This sets up an external MIP (x-MIP) tunnel (x-MIP T) between the MAG and the mobile node's x-CoA. According to a first aspect of a second step, a secure VPN is established. Using IKE, the MN negotiates the IPSec SAs using the x-HoA as one of the tunnel endpoints with the MAG; the other end-point is the MAG's address. According to a second aspect of the second step, MIP registration occurs with the internal home agent (i-HA). Once the VPN tunnel is established according to the second step, the MN registers with the i-HA using the MAG's private address as the i-CoA of the MN. The internal MIP (i-MIP) tunnel (i-MIP T) therefore is established between the i-HA and the MAG. The Mobile IP signaling occurring in the second step is carried through using the secure VPN tunnel established between the MN and the MAG.

For the user traffic from the MN to the CN, the traffic that is sent by the MN using its private address (i-HoA) as the source address to the CN's internal (private) address (i-CN) as the destination address is firstly subjected to ciphering and integrity protection as per the IPSec SAs. The protected traffic is then tunneled using x-MIP T-1 using the MN's x-HoA to the MAG. The MAG decapsulates the datagrams. The MAG then checks the integrity of the traffic and also decrypts the datagrams. The datagrams are then forwarded to the i-CN.

For traffic from the CN to the MN, user traffic sent by the CN using the internal address of the CN (i-CN) as the source address to the MN's private address (i-HoA) as the destination are intercepted by the i-HA and tunneled to the MAG through i-MIP T-1. The MAG then consults a table to resolve the i-HoA to the appropriate x-HoA of the MN. Encryption and integrity checking are applied as per the IPSec SAs to the datagrams. The packets are then tunneled to the MN's x-HoA address. The HA component of the MAG then intercepts the packet and tunnels the secured datagrams to the MN's x-CoA. The MN, on receiving the packets, decapsulates the datagrams and checks the integrity of the packets, decrypts the content which is then processed by the particular application.

In the SUM architecture, in order to provide secure network connection to a MN visiting a foreign network, two MIP tunnels are used. Traffic from a CN goes through the i-HA and then through the x-HA before reaching the MN. In accordance with at least one embodiment of the present invention, a route-optimization technique is used to avoid MIP triangle routing and the disadvantages associated therewith, such as protracted latency.

In accordance with at least one embodiment of the present invention, the i-HA, on intercepting packets on behalf of the MN from the i-CN destined for the MN (i-HoA), informs the i-CN that the MN is outside its home network and informing the CN of the existence of a shorter path to reach the MN via the MAG. Such communication is preferably done using the route-optimization messages defined by Perkins and Johnson (C. Perkins, D. Johnson, Route Optimization in Mobile IP, Internet Draft, 2001). The i-CN then forwards the user traffic destined to the i-HoA directly to the MAG instead of sending them to the i-HA, which would then forward the user traffic to the MAG. Triangle routing between the CN and the MAG is thereby avoided, and, therefore, packets are received relatively faster.

The i-HA, on intercepting packets destined for the i-HoA, sends a Binding Update message to the i-CN containing the internal address of the MAG. The i-CN then creates a binding entry for the i-HoA paired with the MAG's internal address, so that packets destined to the i-HoA are tunneled to the MAG. That may occur instead of sending the packets to the internal home network of MN1. The i-CN then forwards user packets directly to the MAG using the i-MIP route-optimized (1-MIP-RO) tunnel (1-MIP-RO T). The ability of i-CN and the MAG to support MIP route optimization is provided by implementing in them the ability to utilize route-optimization messages.

FIG. 3 is a diagram illustrating connections among elements including a MN 103/104 and a CN 110 in accordance with at least one embodiment of the present invention. The diagram includes vertical lines representing elements including CN 110, i-HA 108 or 109, MAG 105, x-HA 106 or 107, and MN 103 or 104. Relationships between the foregoing elements expressed in the alternative are intended to be understood respectively. Thus, i-HA 108 relates to x-HA 106, which relates to MN 103, and i-HA 109 relates to x-HA 107, which relates to MN 104, as illustrated by the connections of such elements shown in FIG. 1. CN 110, i-HA 108 or 109, and MAG 105 preferably exist within intranet 101. The diagram includes horizontal lines representing communications between elements.

Firstly, a first external mobile-internet-protocol tunnel (x-MIP T-1) 301 is established between MN 103 or 104 and x-HA 106 or 107. An external mobile-internet-protocol (x-MIP) registration request 302 to establish an external care-of address (x-CoA) is communicated from MN 103 or 104 to x-HA 106 or 107. An x-MIP registration reply 303 to establish the external care-of address (x-CoA) is communicated from x-HA 106 or 107 to MN 103 or 104.

Secondly, a VPN tunnel 304 is established between MN 103 or 104 and MAG 105 along x-MIP T-1 301. Communication to establish the VPN tunnel 304, such as internet key exchange (IKE) negotiation, internet protocol security (IPSec) security association (SA) creation, and address assignment occurs according to communication 305 from MN 103 or 104 to MAG 105 and communication 306 from MAG 105 to MN 103 or 104.

Thirdly, a first internal mobile internet-protocol tunnel (i-MIP T-1) 307 is established between MAG 105 and i-HA 108 or 109, and an internet protocol (IP) connection 308 is established between MN 103 or 104 and correspondent node (CN) 110 along the first i-MIP T-1 307, the VPN tunnel 304, and the x-MIP T-1 301. An internal mobile-internet-protocol (i-MIP) registration request 309 is communicated from MN 103 or 104 to i-HA 108 or 109. An i-MIP registration reply 310 is communicated from i-HA 108 or 109 to MN 103 or 104.

Fourthly, route optimization is performed to avoid triangle routing. The x-MIP T-1 301 is replaced with an x-MIP route-optimized tunnel (x-MIP-RO T-1) 3 11 between MN 103 or 104 and MAG 105. A route optimization (RO) binding update 313 to change the x-CoA is communicated from x-HA 106 or 107 to MAG 105. A RO binding acknowledgement 314 to change the x-CoA is communicated from MAG 105 to x-HA 106 or 107. The i-MIP T-1 307 is replaced with an i-MIP-RO T-1 312 between MAG 105 and CN 110. A RO binding update 315 is communicated from i-HA 108 or 109 to CN 110. A RO binding acknowledgement 316 is communicated from CN 110 to i-HA 108 or 109. Thus, communication between MN 103 or 104 and CN 110 can occur via x-MIP-RO T-1 311 between MN 103 or 104 and MAG 105 and i-MIP-RO T-1 312 between MAG 105 and CN 110.

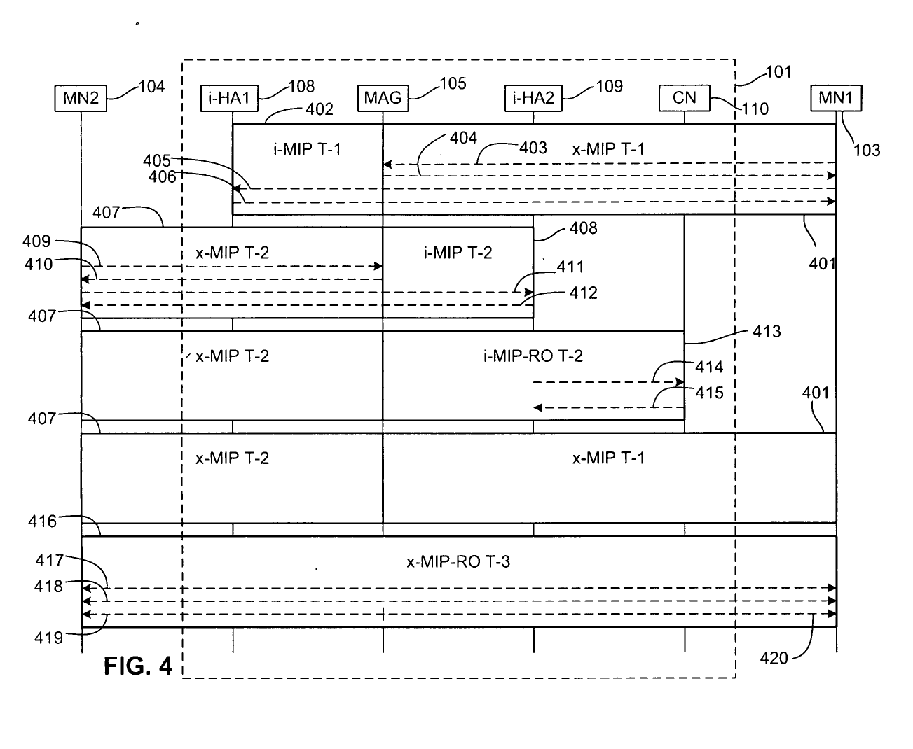

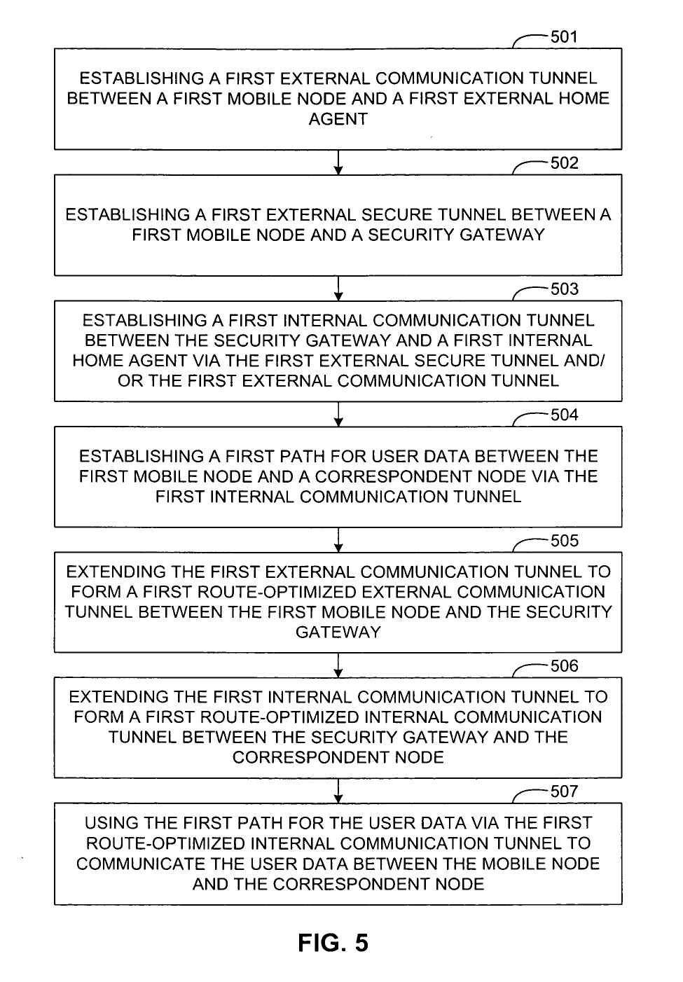

FIG. 5 is a flow diagram illustrating a method involving communication between a MN and a CN in accordance with at least one embodiment of the present invention. In step 501, a first external communication tunnel is established between a first mobile node and a first external home agent. In step 502, a first external secure tunnel is established between a first mobile node and a security gateway (e.g., a MAG). The security gateway can establish a boundary of an intranet (i.e., the intranet is bounded by the security gateway) by implementing security policies controlling communication between the intranet and an external network (e.g., a public network such as the internet) coupled to the MAG. In step 503, a first internal communication tunnel is established between the first security gateway and a first internal home agent via the first external secure tunnel and/or the first external communication tunnel. In step 504, a first path for user data is established between the first mobile node and a correspondent node via the first internal communication tunnel.

In step 505, the first external communication tunnel is replaced to form a first route-optimized external communication tunnel between the first mobile node and the security gateway (e.g., MAG 105). In step 506, the first internal communication tunnel is replaced to form a first route-optimized internal communication tunnel between the security gateway (e.g., MAG 105) and the correspondent node. In step 507, the first path is used for the user data via the first route-optimized internal communication tunnel to communicate the user data between the mobile node and the correspondent node.

FIG. 6 is a flow diagram illustrating a method for practicing step 501 of FIG. 5 in accordance with at least one embodiment of the present invention. In step 601, a first external care-of address registration request is communicated from the first mobile node to the first external home agent. In step 602, a first external care-of address registration reply is communicated from the first external home agent to the first mobile node.

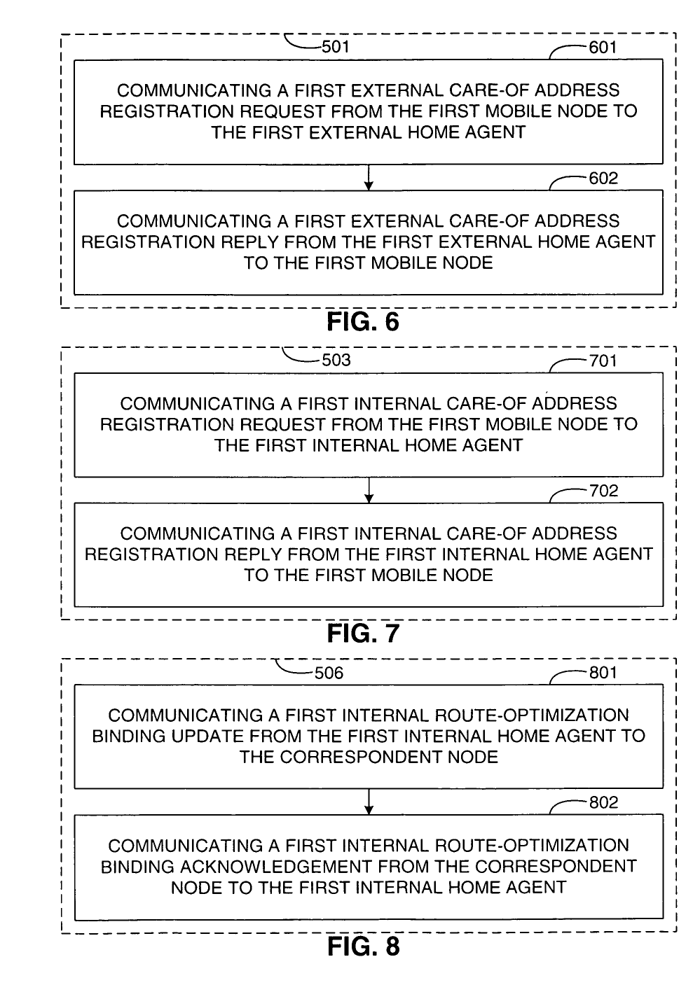

FIG. 7 is a flow diagram illustrating a method for practicing step 503 of FIG. 5 in accordance with at least one embodiment of the present invention. In step 701, a first internal care-of address registration request is communicated from the first mobile node to the first internal home agent. In step 702, a first internal care-of address registration reply is communicated from the first internal home agent to the first mobile node.

FIG. 8 is a flow diagram illustrating a method for practicing step 506 of FIG. 5 in accordance with at least one embodiment of the present invention. In step 801, a first internal route-optimization binding update is communicated from the first internal home agent to the correspondent node. In step 802, a first internal route-optimization binding acknowledgement is communicated from the correspondent node to the first internal home agent.

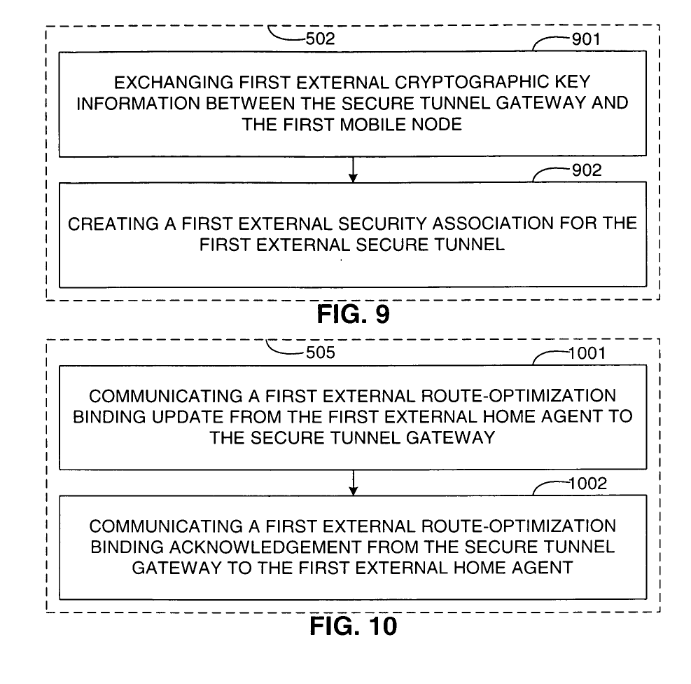

FIG. 9 is a flow diagram illustrating a method for practicing step 502 of FIG. 5 in accordance with at least one embodiment of the present invention. In step 901 security capabilities are exchanged and keys are derived between the security gateway and the first mobile node. In step 902, a first external security association is created for the first external secure tunnel.

FIG. 10 is a flow diagram illustrating a method for practicing step 505 of FIG. 5 in accordance with at least one embodiment of the present invention. In step 1001, a first external route-optimization binding update is communicated from the first external home agent to the security gateway. In step 1002, a first external route-optimization binding acknowledgement is communicated from the security gateway to the first external home agent.

Another problem that has not heretofore been adequately addressed is that of reliable, secure, and efficient communication between MNs that are outside the intranet and residing in the external networks (e.g., in the internet). Communicating MNs have not been guaranteed to receive packets of data destined for them with a level of confidentiality similar to that of an intranet environment and to have a similar level of accessibility since a solution to handle adequately the case where both the MNs communicating with one another are outside a secured intranet has not heretofore been adequately provided.

When one of the two communicating mobiles also decides to move outside (a MN2 that is located within the intranet and communicating with MN1, which is outside the intranet now moves outside the intranet, in short now both the MNs are outside the intranet) the intranet then additional signaling and overhead are expected since the approach as followed above demonstrates the need for two separate VPN, external MIP and internal MIP tunnels have to be setup. One way to reduce the processing overhead involved and also the latency is for the MAG to bridge the tunnels to the MNs. To provide even greater reduction in processing overhead and/or further reducing in latency, the two separate VPN tunnels (from MN1 to the MAG and from MN2 to the MAG) are preferably merged into a single end-to-end VPN tunnel.

The condition when two MNs communicate with one another when they are both outside the intranet (e.g., protected subnetwork) has not heretofore been adequately addressed. Herein a method and apparatus is presented capable of addressing the condition when secure communication between two MNs outside the intranet is desired. This is achieved by combining the VPN-GW with the x-HA into a single entity, we call the Mobility-Aware VPN Gateway (MAG). The MAG bridges the two separate VPN tunnels and two separate MIP tunnels in order to facilitate secure connections between the MNs.

When two MNs are outside the intranet and communication between them is desired, several steps may be performed. Firstly, the MNs perform MIP registration with the x-HA (e.g., with the MAG, wherein the MAG provides the x-HA functionality). Secondly, the MNs establish secure VPN tunnels to the MAG. Thirdly, the MNs perform MIP registration with their respective i-HAs. Such steps are performed by MNs outside the intranet to facilitate secure communication with nodes inside the intranet or with other similarly registered MNs. When MN1 and MN2 perform the above steps, they can establish x-MIP T-1 401, i-MIP T-1 402, x-MIP T-2 407, and i-MIP T-2 408 of FIG. 4. The i-MIP-RO T-2 413, in conjunction with x-MIP T-2 407, can be obtained in accordance with the steps recited for establishing secure communication between one MN and an intranet, for example, as described above with respect to FIGS. 5-10.

Table 1 is an exemplary table with sample entries to reflect the structure of the information maintained by the MAG.

TABLE 1
Example of a Binding Table

| MN | | | | | |
|---|---|---|---|---|---|
| id | x-HoA | i-HoA | x-CoA | SAiD_{to-MN} | SAiD_{from-MN} |
| MN1 | 192.1.3.9 | 10.1.10.6 | 198.12.4.8 | 1387 | 1388 |
| MN2 | 192.1.3.13 | 10.4.7.12 | 133.25.1.7 | 2076 | 2078 |

Updating of binding table entries is performed at the MAG: The table maintained by the MAG is updated to reflect the connections that each MN has with the MAG.

When the first step described above is performed, the MN identifier (MN id), x-HoA and x-CoA values are entered into the table. After the second step described above, Security Association Identifiers (SAiDs) are added for each direction for the particular MN whose x-HoA and i-HoA addresses match the table. The SAiD_{to-MN} is the identifier for the IPSec SA that is negotiated for the traffic from the MAG to MN while SAiD_{from-MN} is the IPSec SA for the traffic from the MN to MAG. Note that the table preferably has an entry mapping the x-HoA to the i-HoA. The values for x-CoA and the SAiDs may be entered after the first and second steps. The third step described above need not have any effect on the table maintained at the MAG. An entry with a non-empty x-CoA field indicates to the MAG that the mobile is outside the intranet.

In accordance with at least one embodiment of the present invention, as discussed with respect to this extension, when a packet destined to a i-HoA is received by the MAG, the MAG checks to see if the i-HoA is paired with a corresponding x-CoA value. If an x-CoA value exists for a particular i-HoA, the MAG determines that the MN whose private address is i-HoA is outside the intranet. Therefore, the MAG recognizes that the packets destined to it need not be forwarded into the intranet. An example of traffic flow from MN1 to MN2 is detailed below.

Firstly, MN1 uses i-HoA1, which is the internal source address of MN1, and sends packet to i-HoA2 (internal address of MN2). Secondly, the VPN application on the MN1 is invoked (since packet has an internal source and destination address). The packet undergoes steps (encryption, integrity value computation, etc.) to conform with the IPSec SA that was negotiated with the MAG. Then the packet is encapsulated with an IP header using x-HoA as the source address. A secure tunnel along X-MIP T-1 between MN1 and the MAG having a destination address of the public address of the MAG is used to transport the packet.

Thirdly, the MIP client application on the MN1 encapsulates the secure packets with another IP header using x-CoA1 as the source address. The x-MIP T-1 tunnel is used which has a destination address of the public address of the MAG is used to transport the MIP packet. Thus, the destination address of the new IP header is the public address of the MAG. (Note: the original packet now preferably has at least three IP headers).

Since the outermost header is destined to the MAG, the MAG is the first to receive the packet and processes the MIP header and discards the header. The MAG then checks the inner header and the packet for conformance to the appropriate IPSec SA. The IPSec SA is obtained by the MAG using the appropriate SAiD_{from-MN} value (1388) from Table 1 for the source MN (in this case i-HoA 1). The SAiD_{from-MN} value is used it to fetch the SA from Security Association Database maintained by the MAG.

If the packet meets the agreed IPSec SA for integrity check and encryption, then the MAG discards the IPSec header and then processes the inner-most header. Since the destination address of the packet is that of i-HoA2, the MAG looks for an entry for i-HoA2 in the table and checks if there is a valid entry for the x-CoA2.

If there is a corresponding x-CoA2, it implies that even i-HoA2 is also outside the corporate network, Then the SAiD_{to-MN} is used to obtain the IPSec SA, and it is applied to the packet. The SAiD_{to-MN} for i-HoA2 is 2076. The SAiDto-MN is used to fetch the SA and the necessary security functions are applied to the packet. A new IP header is appended whose source address is the MAG address and the destination the x-HoA2 address. A secure tunnel between the MAG and MN2 is used to transport the packet. The secure packet is then tunneled using x-MIP-T2 using another IP header (e.g., MIP header) whose source address is that of the MAG and the destination address is the x-CoA2.

In accordance with at least one embodiment of the present invention, several features may be advantageously provided. As one example, the decision of whether or not to send the packet into the intranet may be performed at the MAG itself, thereby avoiding the inefficiency of the packets having to travel all the way to the i-HA before it is determined that the MN is outside the intranet, which not only would cause high latency but also high packet overhead. As another example, MNs that are outside the intranet and that desire to communicate with one another may do so securely and efficiently, with low latency.

While providing secure communication between multiple MNs is beneficial, there can be some amount of overhead at the MAG in having to decrypt and re-encrypt the same user traffic in order to conform to two different IPSec SAs. Such overhead can be reduced by creating an end-to-end (e.g., peer-to-peer) VPN connection between the MNs intended to communicate with each other. The new VPN connection is established between the communicating mobiles using the already established VPN tunnels for new IPSec SA negotiations.

When MN1 sends datagrams intended for the intranet, the VPN client process at MN1 encrypts and adds a VPN header. The MIP client then adds the MIP header and forwards the datagrams to the MAG. Once the packets are decapsulated and decrypted, the MAG then checks to see if the MN2 is inside the intranet. If the MN2 is outside the intranet, the MAG consults the roaming database, determines the x-HoA, and applies the appropriate IPSec SA. The HA entity then encapsulates the datagram to the x-CoA1.

In order to reduce the overhead associated with the decryption and re-encryption of the packets at the MAG, several steps may be performed, as described below. Firstly, the MAG derives keys that can be shared by both the communicating mobiles. A shared key, which is sent by the MAG to both the MNs, can then be used by the MNs to negotiate IKE and IPSec SAs between the two MNs, directly creating a new end-to-end secure VPN tunnel between the two MNs without relying on the MAG. Secondly, the MAG sends a route-optimization message to both the source and destination of the datagrams. The route-optimization messages can be piggybacked as part of the key-distribution. Thirdly, the datagrams from MN1 intended for MN2 are sent using the end-to-end secure tunnel and encapsulated using x-MIP T-3 to the MN2's x-CoA2. Other datagrams from MN1 intended to the nodes within the intranet use the x-MIP T-1 and the VPN tunnel that exists along x-MIP T-1.

Several aspects of providing an end-to-end VPN tunnel between MNs in accordance with at least one embodiment of the present invention may be beneficial in at least some situations. Firstly, the MAG need not decrypt and re-encrypt to conform with the SAs. Secondly, the tunnel that is established is generally the shortest path possible, avoiding triangle routing. Thirdly, updating the routing of traffic in case of movement (e.g., change of x-CoA address) by the MN can occur in one half of a round-trip time (½ RTT) and does not drastically increase the allowed latency for real-time applications.

In accordance with at least one embodiment of the present invention, an end-to-end VPN tunnel between MN1 and MN2 and a corresponding end-to-end MIP route-optimized tunnel between MN1 and MN2 are created. An improvement over separate VPN tunnels and MIP tunnels is not only that route-optimized paths are traversed but also that packets do not have to undergo decryption and re-encryption at the MAG. Another advantage is that the signaling messages in order to create new SAs and MIP tunnels are transported over already established secure VPN tunnels.

Also, communication between the two MNs is route-optimized so that the new MIP tunnel x-MIP-RO T-3 now runs between MN1 and MN2 without being terminated at the MAG. This optimization is preferably initiated by the MAG, which is in a position to be aware of the potential for implementing a route-optimized end-to-end secure tunnel, as it is aware of the existence of the secure tunnels from the MAG to each of the MNs. The MAG, on realizing that the MNs are communicating via split VPN tunnels, initiates an optimization procedure. An example of such an optimization procedure can be expressed in steps as described below. Firstly, the MAG generates shared keys. Secondly, the MAG distributes shared keys via the secure VPN tunnels and also instructs the MNs to start IPSec negotiation between the MNs. Thirdly, the MNs initiate an IKE procedure using the newly obtained keys and establish IPSec SAs. Fourthly, the MAG sends a MIP—Route Optimization message to both MNs. Fifthly, each MN updates its binding update table to reflect the change in MIP tunnel endpoint.

When the MAG recognizes that the MNs are communicating via split tunnels that traverse the MAG, the MAG generates shared keys that can be used to set-up secure peer-to-peer VPN connection between the MNs. Then, the MAG distributes these keys to both the MNs and also instructs the MNs to create IPSec SAs between the MNs. The MAG also sends the external addresses of the MNs to one another. Then, the MNs initiate an IKE procedure between themselves, and new IPSec SAs are created. These SAs that are negotiated between the MNs do not involve the MAG. Any communication between the MNs is then protected by the new SAs. Then, the MAG sends a route-optimization message containing each of the MNs current care-of address. The MNs, on receiving the route-optimization message, update their internal binding entries.

An example of traffic flow between MN1 and MN2 is described below. Firstly, MN1 uses i-HoA1 to send packets to MN2, whose private address is i-HoA2. Secondly, the VPN application on the MN1 is invoked, and the packet undergoes steps to conform with the new IPSec SA that was negotiated with the MN2. Then, the packet is encapsulated with an IP header using x-HoA1 as the source address. The packet is transported using the secure VPN tunnel provided along x-MIP-RO T-3, which has x-HoA1 as the source address and a destination address of x-HoA2. Thirdly, the MIP client application on the MN1 encapsulates the secure packets with another IP header using x-CoA1 as the source address. The secure packets are transported using x-MIP-RO T-3, which has x-CoA1 as the source address. The destination address of the new IP header for use with the x-MIP-RO T3 tunnel is the x-CoA2 (i.e., the care-of address of MN2), unlike the case of MN-to-MN communication through a MAG, where the destination address is that of the MAG. Fourthly, since x-CoA2 is the destination, the MN2 receives the packets and discards the outer MIP header. Fifthly, the MN2 then checks the inner header and the packet for conformance to the appropriate IPSec SA. Sixthly, on conformance to the SA, the IPSec header is also discarded, and the original packet having i-HoA1 as the source address and a destination of i-HoA2 is processed by the application. Each of the MNs is notified about creation of the new VPN connection with communicating peers.

In accordance with at least one embodiment of the present invention, one or more features described below may be implemented, in the context of establishing an end-to-end secure tunnel between communicating MNs. Unlike the case of MN-to-MN communication through a MAG, the MAG need not decrypt and re-encrypt communications to conform with the SAs. The load on the MAG can be greatly reduced, especially if the MAG is serving a number of CNs and MNs. Also, the latency incurred by user traffic because of decryption, re-encryption, and re-tunneling of packets at the MAG can be completely avoided. Furthermore, the tunnel that is established may be selected to be (and preferably is) the shortest path possible, avoiding triangle routing.

FIG. 4 is a diagram illustrating connections among elements including MN1 103 and MN2 104 in accordance with at least one embodiment of the present invention. The diagram includes vertical lines representing elements including MN 1103, CN 110, i-HA2 109, MAG 105, i-HA1 108, and MN2 104. CN 110, i-HA2 109, MAG 105, and i-HA1 108 preferably exist within intranet 101. The diagram includes horizontal lines representing connections between elements.

Firstly, a VPN and an x-MIP T-1 401 are established between MN1 103 and MAG 105. Communication to establish the VPN tunnel, such as internet key exchange (IKE) negotiation, internet protocol security (IPSec) security association (SA) creation, and address assignment, and an x-MIP registration request occurs according to communication 403 from MN1 103 to MAG 105. Further communication to establish the VPN tunnel and an x-MIP registration reply occurs according to communication 404 from MAG 105 to MN 1103. An i-MIP T-1 402 is established between MAG 105 and i-HA1 108. An i-MIP registration request 405 is communicated from MN1 103 to i-HA1 108. An i-MIP registration reply is communicated from i-HA1 108 to MN1 103.

Secondly, a VPN and an x-MIP T-2 407 are established between MN2 104 and MAG 105. Communication to establish the VPN tunnel, such as internet key exchange (IKE) negotiation, internet protocol security (IPSec) security association (SA) creation, and address assignment, and an x-MIP registration request occurs according to communication 409 from MN2 104 to MAG 105. Further communication to establish the VPN tunnel and an x-MIP registration reply occurs according to communication 410 from MAG 105 to MN2 104. An I-MIP T-2 408 is established between MAG 105 and i-HA2 109. An I-MIP registration request 411 is communicated from MN2 104 to i-HA2 109. An I-MIP registration reply is communicated from i-HA2 109 to MN2 104.

Thirdly, route optimization is performed to replace the i-MIP T-2 408 so that i-MIP-RO T-2 413 exists between MAG 105 and CN 110. RO binding update 414 is communicated from i-HA2 109 to CN 110. RO binding acknowledgement 415 is communicated from CN 110 to i-HA2 109.

Fourthly, when communication between MN1 103 and MN2 104 is desired, MAG 105 recognizes the inefficiency of involving i-HA1 108 and i-HA2 109 in the communication and bridges x-MIP T-1 401 and x-MIP T-2 407 (and their respective VPN tunnels) to facilitate more efficient communication with reduced latency between MN1 103 and MN2 104.

Fifthly, route optimization is performed and an end-to-end VPN tunnel and route-optimized x-MIP-RO T-3 416 is established between MN1 103 and MN2 104. MAG 105 determines that MN1 103 and MN2 104 could communicate with each other without the need for their traffic to pass through MAG 105 (e.g., that MN1 103 and MN2 104 are reachable from each other over a common network). Preferably, as one example, MAG 105 derives a cryptographic key and distributes the cryptographic key to at least one of MN1 103 and MN2 104 so as to effect establishment of a cryptographically secured link (e.g., secure tunnel) between MN1 103 and MN2 104. As another example, communication 417 occurs between MN1 103 and MN2 104 to perform cryptographic key generation and distribution to establish the VPN tunnel between MN1 103 and MN2 104. Communication 418 occurs between MN1 103 and MN2 104 to perform IKE negotiation and IPSec SA creation between MN1 103 and MN2 104 to establish the VPN tunnel between MN1 103 and MN2 104. A RO binding update 419 to communicate the x-CoA1 (the external Care-of-Addiess of MN1) is communicated from MAG 105 to MN2 104. A RO binding update 420 to communicate the x-CoA2 (Care-of-Address of MN2) is sent by the MAG 105 to MN1 103. Thus, MN1 103 and MN2 104 are able to communicate efficiently with reduced latency along the end-to-end VPN tunnel directly between MN1 and MN2 using the tunnel x-MIP-RO T-3 416. By bridging, at the security gateway (e.g., MAG 105), the communication between the first mobile node (e.g., MN1 103) and the second mobile node (e.g., MN2 104) such that the first internal communication tunnel (e.g., i-MIP T-1 402) and the second internal communication tunnel (e.g., i-MIP T-2 408) are not needed to convey the communication between the first mobile node and the second mobile node.

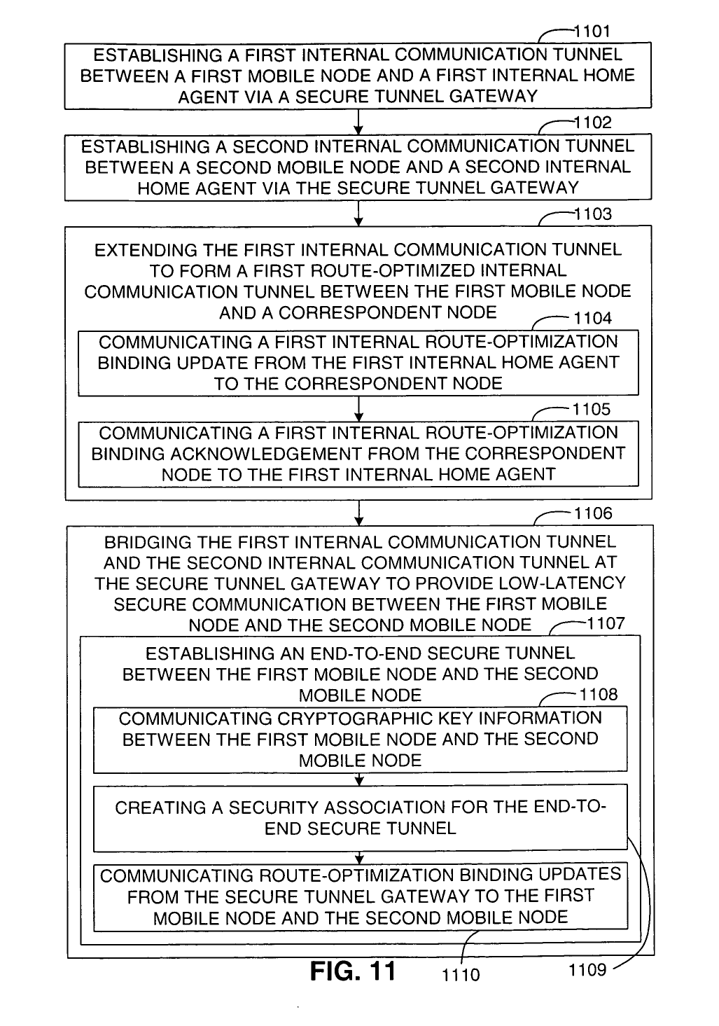

FIG. 11 is a flow diagram illustrating a method involving communication between a first MN and a second MN in accordance with at least one embodiment of the present invention. In step 1101, a first internal communication tunnel is established between a first mobile node and a first internal home agent via a security gateway. In step 1102, a second internal communication tunnel is established between a second mobile node and a second internal home agent via the security gateway.

In step 1103, the first internal communication tunnel is changed to form a first route-optimized internal communication tunnel between the first mobile node and a correspondent node. Step 1103 may comprise steps 1104 and 1105. In step 1104, a first internal route-optimization binding update is communicated from the first internal home agent to the correspondent node. In step 1105, a first internal route-optimization binding acknowledgement is communicated from the correspondent node to the first internal home agent.

In step 1106, the first internal communication tunnel and the second internal communication tunnel are bridged at the security gateway to provide low-latency secure communication between the first mobile node and the second mobile node. Step 1106 may comprise step 1107, in which an end-to-end secure tunnel is established between the first mobile node and the second mobile node. Step 1107 may comprise steps 1108, 1109, and 1110. In step 1108, cryptographic key information is communicated between the first mobile node and the second mobile node. In step 1109, a security association is created for the end-to-end secure tunnel. In step 1110, route-optimization binding updates are communicated from the security gateway to the first mobile node and the second mobile node.

For real-time applications, the latencies incurred by the triangle route and its effects, namely the decryption, re-encryption and re-tunneling at the MAG may be avoided in accordance with at least one embodiment of the present invention. The benefit of avoiding such latencies may be further magnified when session continuity is required between heterogeneous radio access or in a highly mobile environment, as such session continuity requirements can exacerbate communication impairments arising from such latencies.

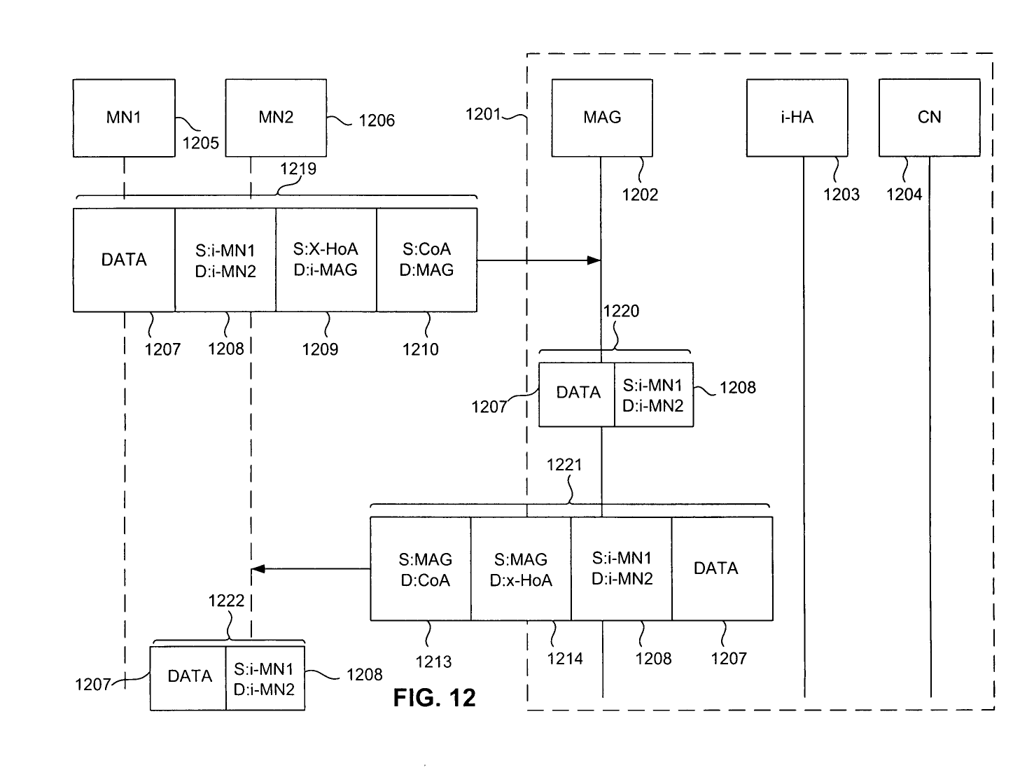

FIG. 12 is block diagram illustrating information communicated in accordance with at least one embodiment of the present invention. Intranet 1201 comprises MAG 1202, i-HA 1203, and CN 1204. First MN 1205 and second MN 1206 are operably coupled to MAG 1202. MN1 communicates a message 1219 to MAG 1202. Message 1219 comprises data 1207. Header 1208 has been added to data 1207. Header 1208 indicates message 1219 has a source of i-MN1 and a destination of i-MN2. Header 1209 has been added to data 1207 and header 1208. Header 1209 indicates message 1219 has a source of X-HoA1 and a destination of i-MAG. Header 1210 has been added to data 1207 and headers 1208 and 1209. Header 1210 indicates message 1219 has a source of CoA and a destination of MAG. As the outermost header, header 1210, indicates a destination of MAG, message 1219 is sent to MAG 1202, which is its own address, and therefore MAG 1202 processes the next header. MAG 1202 removes header 1210 and determines header 1209 indicates a destination of i-MAG, which is its own address, and therefore MAG 1202 processes the next header. MAG 1202 removes header 1209 to obtain message 1220 and determines header 1208 indicates a destination of i-MN2. MAG 1202 consults the table and adds header 1214 to message 1220, indicating a source of MAG and a destination of x-HoA2. MAG 1202 adds header 1213 indicating a source of MAG and a destination of x-CoA2, thereby yielding message 1221. Since the destination of the packet is x-CoA2, which is MN2's 1206 care-of-address, MN2 1206 receives the packet and then the header 1213 is removed from message 1221 by MN2. Header 1214 is also removed by MN2 (after MN2 verifies the integrity and/or authenticity of the message in accordance with the SA that was established earlier) from message 1221, yielding message 1222 comprising data 1207 and header 1208, which indicates a source of i-MN1 and a destination of i-MN2. Accordingly, data 1207 is communicated to the application at the MN2 1206.

Accordingly, a method and apparatus for providing low-latency secure session continuity between mobile nodes is described. It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. A method comprising:
establishing a first internal communication tunnel between a first mobile node and a first internal home agent via a security gateway;
establishing a second internal communication tunnel between a second mobile node and a second internal home agent via the security gateway;
bridging, at the security gateway, the communication between the first mobile node and the second mobile node such that the first internal communication tunnel and the second internal communication tunnel are not needed to convey the communication between the first mobile node and the second mobile node.

2. The method of claim 1 further comprising:
checking a binding table entry of a binding table to determine whether a destination of data from the first mobile node is a second mobile node outside of an intranet having a boundary established by the security gateway.

3. The method of claim 2 wherein checking the binding table entries further comprises:
checking, in the binding table, to determine content of an external care-of address field for the second mobile node.

4. The method of claim 3 wherein checking, in the binding table, to determine the content of the external care-of address field for the second mobile node further comprises:
when the external care-of address field for the second mobile node is non-empty, determining that the second mobile node is outside the intranet.

5. The method of claim 2 further comprising:
adding headers to the data, the headers comprising routing headers and virtual private network (VPN) headers, wherein the VPN headers are derived from security association identifiers (SAiDs) stored in the binding table.

6. The method of claim 1 further comprising:
adding headers to data being communicated to a mobile node selected from the first mobile node and the second mobile node, the headers comprising routing headers and virtual private network (VPN) headers, wherein the VPN headers are derived from security association identifiers (SAiDs) stored in a binding table.

7. The method of claim 6 further comprising:
storing addressing information for the mobile node in the binding table.

8. The method of claim 7 wherein storing the addressing information for the mobile node in the binding table further comprises:
storing an external home address of the mobile node, an internal home address of the mobile node, and an external care-of address of the mobile node in the binding table.

9. The method of claim 8 wherein the SAiDs stored in a binding table comprise first SAiDs applicable from the mobile node to the security gateway and second SAiDs applicable from the security gateway to the mobile node.

10. The method of claim 1 wherein establishing the first internal communication tunnel between the first mobile node and the first internal home agent via the security gateway further comprises:
performing mobile internet protocol (MIP) registration of the first mobile node with a first internal home agent.

11. The method of claim 10 wherein performing MIP registration of the first mobile node and the first internal home agent further comprises:
using the security gateway's private address as a first internal care-of address of the first mobile node.

12. The method of claim 11 further comprising:
establishing a first external communication tunnel between the first mobile node and a first external home agent.

13. The method of claim 12 wherein establishing the first external communication tunnel further comprises:
establishing the first external communication tunnel between the security gateway and a first external care-of address of the first mobile node.

14. The method of claim 12 wherein establishing the first external tunnel further comprises:
performing MIP registration with a first external home agent.

15. The method of claim 12 further comprising:
establishing a first external secure tunnel between the first mobile node and the security gateway.

16. The method of claim 15 wherein establishing the first external secure tunnel further comprises:
establishing a first virtual private network (VPN) between the security gateway and a first external home address of the first mobile node.

17. Apparatus comprising:
a first mobile node;
a first home agent coupled to the first mobile node via a first internal communication tunnel;
a second mobile node;
a second home agent coupled to the second mobile node via a second internal communication tunnel;
a security gateway coupled to the first internal communication tunnel and the second internal communication tunnel, wherein the security gateway bridges communication between the first mobile node and the second mobile node such that the first internal communication tunnel and the second internal communication tunnel are not needed to convey the communication between the first mobile node and the second mobile node.

18. The apparatus of claim 17 wherein the security gateway maintains a binding table comprising binding table entries containing addressing information for the first mobile node and the second mobile node.

19. The apparatus of claim 18 wherein the addressing information comprises a first external home address for the first mobile node and a first internal home address for the first mobile node.

20. The apparatus of claim 19 wherein, when the first mobile node is outside of an intranet bounded by the security gateway, the addressing information further comprises a first external care-of address for the first mobile node.
